(19) United States
(12) Patent Application Publication
(10) Pub. No.: US 2020/0331784 A1
(43) Pub. Date: Oct. 22, 2020

(54) PLANT AND METHOD FOR TREATING URBAN WASTE WATER

(71) Applicants: CONSIGLIO NAZIONALE DELLE RICERCHE, Roma (IT); CISA S.p.A., Massafra (TA) (IT)

(72) Inventors: Claudio Di Iaconi, Bari (IT); Marco De Sanctis, Bari (IT); Lorenzo Ferrara, Bari (IT)

(21) Appl. No.: 16/763,313

(22) PCT Filed: Nov. 16, 2018
(86) PCT No.: PCT/IB2018/059030

§ 371 Date: May 12, 2020

(30) Foreign Application Priority Data
Nov. 16, 2017 (IT) 10201700130809

(51) Int. Cl. C02F 3/12; C02F 3/06; C02F 3/10

(52) U.S. Cl. CPC C02F 3/1278; C02F 3/06; C02F 3/104; C02F 3/108; C02F 2303/16; C02F 2203/006; C02F 2209/08; C02F 2301/046; C02F 3/109

(57) ABSTRACT

A urban waste water treatment plant, comprising: a tank subdivided in at least two distinct portions, said at least two distinct portions comprising at least an accumulation area of the sludge and at least an accumulation area of the liquid phase; at least a feeding pipe of the waste water to be treated; at least a recirculation pipe of the liquid phase; at least a discharge pipe of the effluent treated, withdrawn from at least one area of the liquid phase, characterized in that said feeding pipe of the waste water to be treated is configured so that the waste water is inlet on the bottom of said at least one sludge area and in discontinuous mode; inside said at least one sludge area it is provided porous material, contained between two containment planes, configured to allow the filtration of the waste water with removal of the suspended material.

### BACKGROUND OF THE INVENTION

### 1. Field of the Invention

The present Patent application for industrial invention relates to an urban waste water treatment plant, and to the treatment process which can be carried out by means of such plant, able to reduce the sludge quantity to be disposed of compared to the currently known techniques at the state of the art.

In particular, and as better described in the following, the present invention relates to a biological process with sludge age greater than 100 days, able to reduce the sludge quantity to be disposed of up to 80%. This process can be obtained conveniently both by the realization of new plants and by converting the stage of activated sludges of an existing urban waste water purification plant.

### 2. Brief Description of the Prior Art

Nowadays, the management of the purification sludges represents one of the main problems in the whole treatment cycle of urban sewage. In fact, even if the sludges volume produced by an urban waste water purification plant represents only 1-2% of the volume of the waste water flowing in the plant, its treatment and final disposal can bear up to 60% on the purification costs. Therefore, among waste water purification plants managers there is currently a strong interest in technological solutions able to reduce the production of sludges to be disposed of.

The currently available approaches for the reduction of purification sludges are divided in two great groups: those acting on the water line and those acting instead on the sludge line. The first ones are particularly interesting since they handle the problem of the sludges at its origin, thus reducing the quantity to send to the sludge line of the purification plant. The plant according to the present invention acts on the water line of a purification plant.

The currently available technologies for the reduction of sludges production in the water line are based on: (i) the cell lysis and cryptic growth, (ii) the metabolic decoupling or (iii) the maintenance energy.

The main disadvantage of the techniques based on cell lysis and cryptic growth is that chemicals and operational conditions to be used to obtain high sludge reductions can impair seriously the purification process, besides making the process expensive. Examples of processes of this kind available on the market are Lyso™ (Rivoira-Praxair), Biolysis® (Ondeo-Degremont), Aspal™ (Air Liquide), Bioleader™ (Kurita Water Industries Ltd). The processes exploiting metabolic decoupling are simple to be implemented, even if they can have environmental pollution problems due to xenobiocity of the substances used in the process. If decoupling is obtained by alternating oxic and anaerobic conditions (without using xenobiotic substances), the reduction of the sludge quantity does not usually exceed 50%. Examples of processes of this kind, available on the market, are the Cannibal® system (Siemens), alternate cycles in Water® line (Ingegneria Ambiente) and OSCAR (ETC—Engineering solutions).

The processes exploiting the cell maintenance are based on the increase in sludge concentration inside the biological tanks, to reduce the net growth yield. In the traditional systems with activated sludges, such strategy is sensibly hindered by the fact that the tank sludge concentration cannot be increases beyond a certain value since, owing to its low separation speed from the liquid phase, it would be needed secondary settlers with considerable dimensions. Moreover, the increase in the sludge concentration would arise serious problems for its suspension in the biological tank. The problems linked to the great dimensions of secondary settlers can be solved by using membranes, i.e. transforming the process with activated sludges in an MBR system (Membrane Biological Reactor). Anyway, there persist the problems linked to the high concentrations of sludge suspended in tank which can cause membranes dirtying problems, with the need of very frequent cleaning operations, limitations in oxygen transferring and reduction of sludge biologic activity.

Some Patent documents deal with the described problems and try to provide devices able to optimize the sludge removing process.

Document EP1373146 describes a plant comprising a biofilter with a support for sludge having a surface of at least 50 m² per m³ of biofilter volume. Said support for sludge is made up of plastic movable elements which can be packed so that they cannot move.

The plastic movable elements are described, for example, in the document U.S. Pat. No. 5,458,779, as plastic elements with a surface twice the surface of smooth elements with same dimensions, and density little lower than 1 kg/dm3. The linear dimensions of the elements are between 0.5 and 1.5 cm, and the preferred shape is the one of tube pieces provided with inner partitions, for example cross shaped, and possibly tongues of the outer surface of the tube.

Document CN105399285 describes a continuous treatment plant comprising an anaerobic and aerobic stage in series which uses selected microorganism strains, and which uses a filling material with a porosity higher than 90% and a specific surface greater than 20 m²/g.

In document EP2307323 it is described a plant for civil and industrial sewage purification, comprising a biofilter containing supporting means for sludge and an aeration basin provided with a device for insufflating air and connected to said biofilter by means of pipes apt to allow the circulation of sewage from said tank to said biofilter and vice versa. The supporting means suggested in EP2307323 have porosity between 60 and 80% and dimensions of voids between 50 and 80 mm3. The plant described in EP2307323 allows to carry out a discontinuous purification process in which sewage is circulated between the aeration basin and the biofilter and is subjected sequentially to aeration steps in the basin and biological oxidation in the biofilter. Anyway, the plant described in document EP2307323 has some technical limits: in particular the plant needs two basins (biofilter and aerator) and the circulation between the two of them occurs by means of a pipe and dedicated pumping means. Obviously the fact that the whole flowrate has to pass through a pipe and so has to be let in a very limited area of the aerator, besides increasing sensibly the flow speed generates also problems of lack of homogeneity of the liquid phase (phenomenon which becomes more marked with plant dimension increase) compared to the solution according to the present invention which will be described in the following. Moreover, the plant described in EP2307323 uses a compacting material with a porosity lower than 80%. Since porosity is the space of the material which can be destined to sludge, it is quite clear that increasing the porosity value allows to increase, with equal basin dimension, the space destined to sludge and, so to reduce the frequency of cleaning operations, and so the production of sludge. Moreover, the plant described in document EP2307323 provides the inlet of waste water to be treated exclusively in the aerator. Considering that the waste water entering the plant contains suspended material, the plant described in EP2307323 does not allow to carry out a separation of liquid and solid phase, as instead can be obtained with the plant and method described in the following.

In fact, at the end of the addition of the waste water in the aerator there can be reached high concentrations of suspended solids. Therefore, even if in the description of EP2307323 there is indicated the oxygen delivery in an area free of suspended material, this does not occur really.

Moreover, the aerator, both in case of mechanical mixing and with air, functions comparably to a complete mixing reactor. Considering that the waste water is added to a portion of effluent provided in the aerator, such configuration (i.e. the addition of waste water in a complete mixing basin) can lead, especially in case of not very concentrated urban waste water (i.e. that for example produced in areas with high water provision or relating to sedimented discharges), to a rather strong dilution of the aerator content (in terms of composition of the various pollutants) with negative side effects on the sludge compactness due to a little pronounced alternation of “feast” (abundance) and “famine” (famine) conditions of organic substrates (pollutants commonly present in urban sewage) which is basic for the selection in the sludge of species with low growth rate. In other words, the waste water which is really supplied to the biofilter is not the discharge to be treated but the one deriving from its dilution with the purified effluent. This determines a reduction of the value of some parameters of what is supplied to the biofilter, simply under the effect of dilution. For example, the concentration of COD (“chemical oxygen demand”) could not be enough for causing those “storage” phenomena (storage) to occur, which are activated by the alternation of the “feast” (abundance) and “famine” (famine) conditions and which are decisive for the formation of granular sludges, which form the basis of the present invention, as well as the compactness of traditional sludges such the ones of the invention EP2307323.

In the document U.S. Pat. No. 3,956,128 it is described a system for sewage treatment by means of the “contact-stabilization” process. The device described comprises a first area (contact area) in which the waste water to be treated is inlet, which is immediately oxygenated by insufflating air and mixed with the sludge present in the system. The suspended mix (comprising both sludge and waste water) is then passed through a spiral pipe, oxygenated again with air and then introduced in the second area (stabilization area). In such area (partially filled with porous material) the degradation of the organic material adsorbed on the sludge as well as the separation of the solid phase (sludge) from the liquid phase (effluent) is completed. This last one is discharged by gravity from the bottom of the reactor, while the sludge is partially held by the filling material and partially recirculated in the first area to start a new sequence of the contact-stabilization process. The process described in U.S. Pat. No. 3,956,128 A has some technical limits, which are also common to many treatment systems with activated sludges. First of all the waste water is constantly supplied, oxygenated and mixed to sludge; these conditions of high presence of oxygen, both dissolved and in bubble shape, and substrate limit the efficacy of the reduction of the sludge production (as better described in the following). Secondly, it is not provided a tank in which there is only treated liquid, but in both the tanks there are provided both liquid and sludge, and this prevents from realizing different conditions between the two tanks, optimized as a function of the matrix contained therein.

Finally, since in the second tank both sludge and liquid are provided, it cannot be supposed the use of a pump for the extraction of the treated effluent, whose flowrate is so significantly influenced by the percolation speed through the porous means provided in the stabilization area which tends to be occluded while the system functions. Therefore, frequent cleaning of such porous means can be supposed.

### SUMMARY OF THE INVENTION

The plant according to the invention, by means of the configuration of the plant elements (tanks compartmentation, adoption of a suitable filling material and waste water movement systems) and by means of the adoption of particular operational conditions (waste water supplying mode and management of the organic load during starting), allows to transform the existing activated sludge in a particular kind of sludge, made up of biofilm and granules bounded in a plastic porous means.

Moreover, the physical features of the plant (in particular the tank compartmentation and the compartments filling with a plastic supporting means with determined features) and the obtained sludge (in particular the high compactness and the fact that it has its own shape and volume) allow to obtain the separation of the sludge from the liquid phase at the same time of the treatment, thus allowing to reach high concentrations without the need of a sedimentation stage.

Another advantage, which will be clear in the following, is that the plant according to the invention has a simplified treatment scheme compared to the treatment schemes known at the state of the art, since the only one basin can replace the whole water line of the purification plant (the primary and the secondary sedimentation are no more needed) and part of the sludge line (the anaerobic/aerobic digestion stage is no more needed since the very reduced sludge quantity produced results yet stabilized).

Yet, another advantage of the plant and method according to the invention is that the synergic effect deriving from the waste water supplying discontinuous mode, from the waste water supplying from the bottom of the sludge area, from the movement by plug of the waste water in the sludge area (due to the little porosity determined by the high sludge quantity provided) and from the absence of oxygen added to the waste water in the first part of the treatment, allow to obtain and maintain in time a particular kind of sludge (not known at the state of the art), made up of biofilm and granules bounded in a plastic porous means with determined features, which results to be mainly made up of bacterial species able to store the organic material present in the waste water and which result to have a low growth rate (and so little sludge production), which in the operational conditions of the plants known at the state of the art cannot predominate.

Therefore, aim of the present invention is to provide an urban waste water treatment plant which overcomes the limits linked to the embodiments known at the state of the art, and at the same time is able to reduce significantly the quantity of sludge which is usually produced during purification.

In particular the present invention provides an urban waste water treatment plant in which the only one tank, which is also yet provided in the existing plants, can carry out the function of sludge separation from the liquid phase and their respective containment (this is a particularly important feature in the existing little plants, which are usually made up of a single tank), in which the linear circulation speeds of the liquid phase, at equal flowrate and plant dimension, are lower than the circulation speeds needed in the plants known at the state of the art, and in which the features of the porous means and the process conditions are configured to maximize the volume which can be occupied by the sludge and to optimize the features in terms of compactness and stability. According to another aim, the present invention provides an urban waste water treatment plant which allows to implement a biological process able to increase the concentration of sludge present to reduce the quantity of sludge in excess to be disposed of compared to what occurs with the plants known at the state of the art, and which allows to obtain, in the plant outlet, a yet stabilized excess sludge, i.e. having an organic content lower than 60%.

Yet, according to another aim the present invention provides a way to separate the suspended sludge in the tank with activated sludge of a purification plant by bounding it and compacting it in a plastic porous means with determined features in order to avoid the solid-liquid separation stage (known also as secondary settler) which usually represents the bottleneck of traditional purification plants based on the process with activated sludge.

Yet, according to another aim the present invention provides a way to bound in the inner voids of a plastic porous means with determined features, as well as in the spaces generated by its packing, quantities of sludge up to 10 times higher than the ones present in the tanks with activated sludges.

Yet, according to another aim the present invention provides a way to provide a granular sludge bounded in the pores of a plastic porous means with determined features.

The present invention realizes the prefixed aims since it is an urban waste water treatment plant, comprising:
a tank (1) subdivided in at least two distinct portions (2, 3), said at least two distinct portions (2, 3) comprising at least an accumulation area of the sludge (2) and at least an accumulation area of the liquid phase (3),
at least a feeding pipe of the waste water to be treated;

at least a recirculation pipe of the liquid phase; at least a discharge pipe of the effluent treated, withdrawn from said at least one liquid phase area (3), characterized in that

said feeding pipe of the waste water to be treated is configured so that the waste water is inlet on the bottom of said at least one sludge area and in discontinuous mode;
inside said at least one sludge area (2) it is provided porous material, contained between two containment planes, configured to allow the filtration of the waste water with removal of the suspended material;
said tank (1) is subdivided in said at least two distinct portions by means of one or more vertical partitions (23) lower than the walls of the tank (1), so that the liquid from which the suspended material was removed in said at least one sludge area (2) can overflow from said at least one sludge area (2) to said at least one liquid phase area (3);
the bottom of said at least one liquid phase area (3) is connected with the bottom of said at least one sludge area (2) by means of a pipe and pumping means which allow the liquid to recirculate from the bottom of the liquid phase area (3) to the bottom of the sludge area (2).

The invention provides further a method for urban waste water treatment, comprising the steps of:
introduction of the waste water to be purified, previously screened or sedimented, on the bottom of said at least one sludge area (2), so that the waste water crosses bottom-up said porous material by plug movement, thus separating from the suspended solids, and arrives up to the level of said partitions (23), from which the only liquid phase of the waste water falls in said at least one liquid phase area (3),
recirculation of the liquid from the bottom of said liquid phase area (3) to the bottom of said sludge area (2), so that the liquid rises again, with a geometric rising speed between 1 and 5 m/h, along the height of said at least one sludge area (2), crossing said porous material, and arrives up to the level of said partitions (23), to fall then again in said at least one liquid phase area (3), from the bottom of which it is again and repeatedly sent, by means of said pumping means, to the bottom of said sludge area (2);
oxygenation of the liquid phase provided in said at least one liquid phase area (3) by insufflating air and/or injection of pure gaseous oxygen in the recirculation current of the liquid phase or on the bottom of said at least one sludge area;
extraction of the waste water treated from said at least one liquid phase area (3).

### BRIEF DESCRIPTION OF THE DRAWINGS

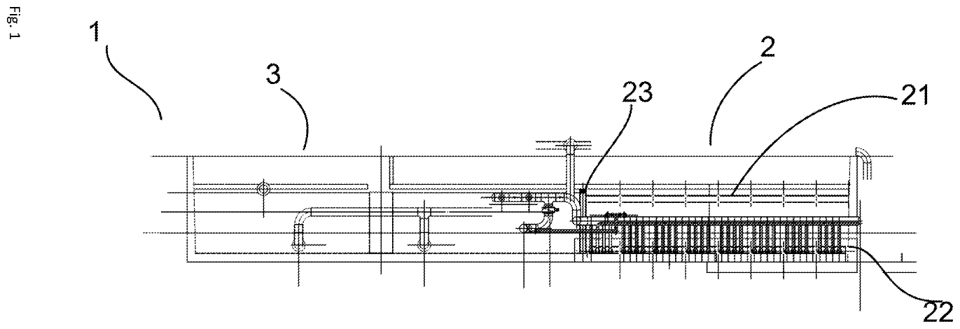

These and other advantages will be clear from the detailed description of the plant and the relative treatment process, which will be described in the following with reference to the appended FIGS. 1 to 4.

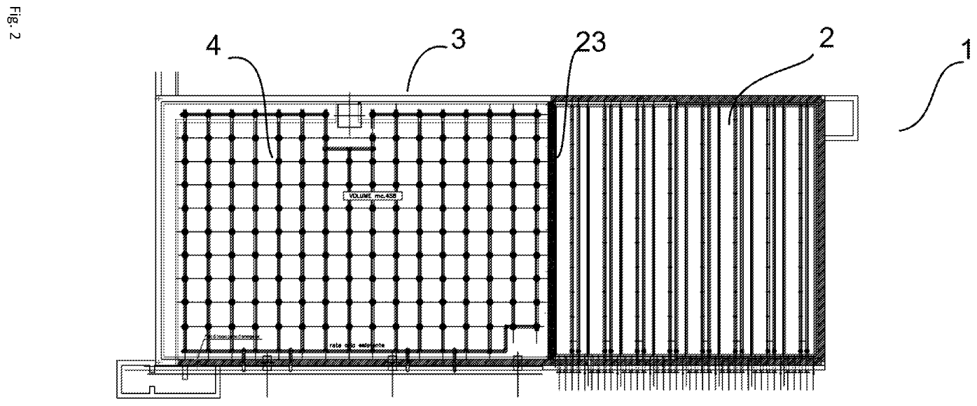

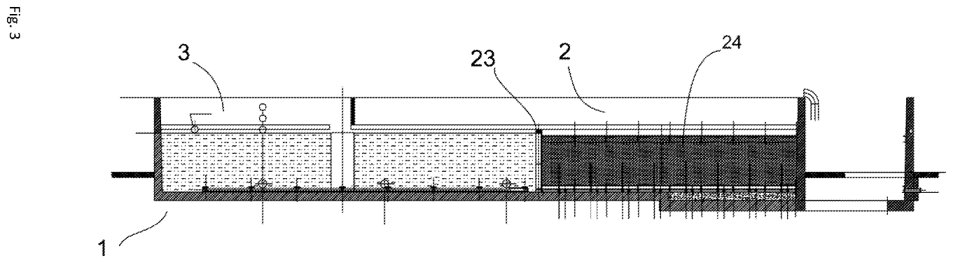

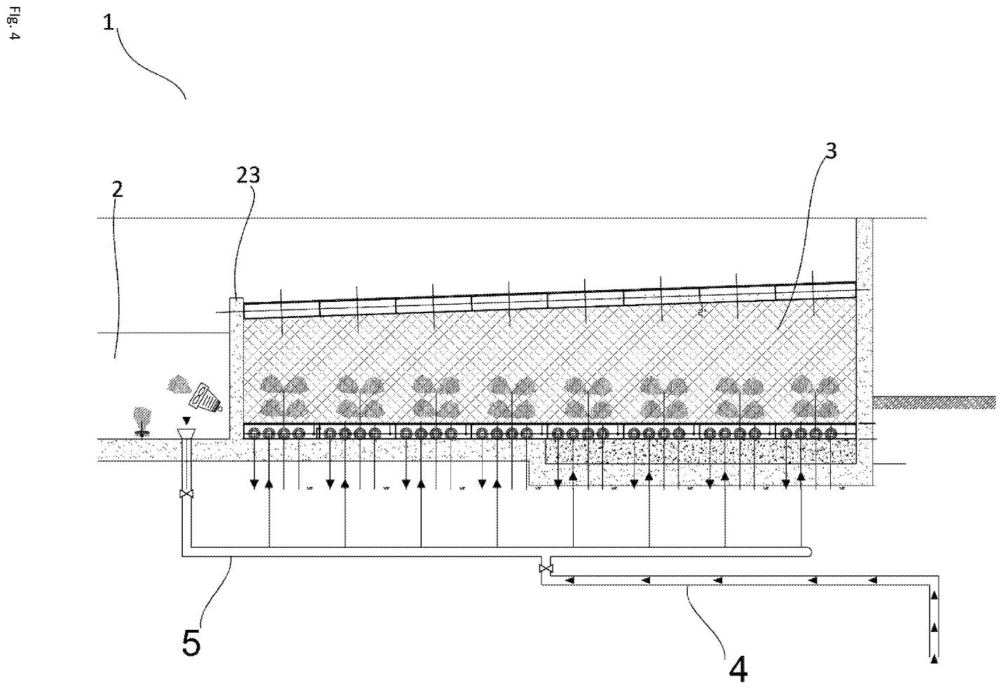

In FIGS. 1 and 3 there are shown two sectional views of a preferred embodiment of the plant according to the invention, in which it is shown a tank in which a partition is realized to create two distinct areas, the sludge area and the liquid phase area; in FIG. 2 it is shown a top view of the same tank. In FIG. 4 it is shown a sectional view of the tank with the indication of the waste water feeding pipe.

### DETAILED DESCRIPTION OF THE INVENTION

Before the following description, it is to be said that the plant object of the present invention can be obtained simply by modifying the tanks of existing treatment plants. Therefore, the process according to the invention can be obtained conveniently both by means of the realization of news plants and by converting the stage of activated sludge of an existing waste water purification plant.

With sludge it is intended the microbial group provided in the biological stage of a purification plant able to hold the suspended material and to remove pollutants present in the sewage. The sludge is the quantity of solids which is determined gravimetrically after drying at 105° C. what is held by a filter having a porosity of 1.2 um. The quantity of sludge is expressed as the weight per volume (gSS/I). The organic content of sludge, expressed as weight per volume (gSV/I) is instead determined by difference between residue at 105° C. and 600° C.

The net growth yield of the sludge in a reactor, Yn, is the quantity (weight) of sludge forming for quantity (weight) of removed pollutant, present both in suspended and soluble form. It is given by the difference between the growth linked to the consumption of the pollutant (Y) and the decay:

Yₙ=Y−bX(−dS/dt)⁻¹ (1)

where:
b is the decay rate, which considers all the factors responsible for the sludge concentration reduction (endogenous metabolism, death, lysis and sludge predation) [hr⁻¹]
X is the sludge concentration [quantity of solids per volume of reactor; gSS/I]
(−dS/dt)⁻¹ is the opposite of the substrate consumption speed per concentration unit of the sludge (X) [h].

It is clear from the analysis of equation 1 that with the increase in the sludge concentration inside the reactor there is a reduction of net growth yield. The increase in the sludge concentration is obtained by increasing its hydraulic residence time in the reactor (also known as the sludge age). thus increasing its uptake in the system. With sludge age or sludge residence time in the reactor it is intended the average residence time interval of the same inside the reactor, which can be calculated also as the ratio between the sludge quantity in the reactor and the outlet flowrate of the same.

In the traditional systems with activated sludge, the possibility to increase the sludge residence time (sludge age) is sensibly hindered by the fact that the sludge concentration in the tank cannot be increased beyond a certain value since, owing to its low separation speed from the liquid phase, there would be needed secondary settlers with considerable dimensions. Moreover, the increase in the sludge concentration could arise serious problems for its suspension in the biological tank. Moreover, in the systems known at the state of the art, the imposed oxygenation conditions limit the possibility to accumulate efficiently the sludge in the reactor (and so to reduce the production of sludge), for two different reasons. First of all the presence of air bubbles tends to favour scouring phenomena of the sludge (i.e. detachment and dragging upwards of the sludge) present on the filling means. Secondly, the presence of high quantities of oxygen together with the continuous and discontinuous supplying of the waste water to be treated favors the development of microbial species with high growth rate (and so with high production of sludge) which, by expanding, cover physically the species with low growth rate, which are inevitably repressed.

The solution to this problem is provided by the plant and method according to the present invention by means of the adoption of plant modifications and modifications of the operational conditions which, in place of a sludge suspended in the sewage, allow to obtain from the activated sludge a particular kind of sludge made up of biofilm and granular sludge, bounded in a plastic porous means, which occupies part of the tank volume, and a sludge-free liquid phase.

With granular sludge it is intended a particular kind of biofilm which has chemical-physical features rather different from the ones of activated sludge.

In particular a granular sludge has:
a sludge volume index (defined as the volume occupied by 1 g of sludge after 30 minutes of sedimentation) lower than 70 ml/g;
a sedimentation speed higher than 3 m/h;
a dimension of particles greater than 0.2 mm;
a layer structure of the microbial populations.

In the plants according to the invention, the transformation of the activated sludge in sludge made up of biofilm and granular sludge occurs in consecutive distinct steps, described in the following.

It is to be specified that the steps described in the following are referred to the starting step of a new plant, defined as the time interval between the setting at work of the new plant and the first cleaning operation which identifies the completion of the transformation of the activated sludge in biofilm and granular sludge.

In the first step, the activated sludge is trapped in the filling means present in the sludge area (which in this step is free of sludge). In the next step, the fraction of the activated sludge adhered on the surface of the filling means leads to the formation of a sludge layer (biofilm) covering the whole surface of the supporting means. The activated sludge trapped in the interstitial pores of the filling means, both the inner ones of the same material and the ones generated by its packing in the sludge area, continues to develop instead as separated entity (inclusion sludge).

In order to improve the sludge compactness, avoiding that the same can be dragged by the waste water and liquid flow thus allowing its increase in weight and volume, there are adopted particular operational conditions: the volumetric organic load (defined as the quantity of COD (oxygen chemical demand) inlet in the plant a day and per volume of sludge area during the first two months from the starting step has to be lower than 0.15 kg of COD for m³ of filling material (i.e. for m³ of sludge area) and a day (kgCOD/m³-d), and the effective rising speed of the liquid in the sludge area has to be between 2 and 5 m/h, and preferably between 2.5 and 3.5 m/h.

The geometric rising speed is defined as the ratio between the recirculation flowrate between the area of the liquid phase and the one of the sludge (expressed in m³/h) and the geometric section of the sludge area (expressed in m²); the effective rising speed is defined as the product between the geometric rising speed and the porosity of the sludge area at a determined time t. St a time t=0 (i.e. when the plant is started), the porosity of the sludge area coincides with the porosity of the filling means (since the sludge is not present) and so the effective rising speed is equal to the product of the geometric rising speed for the porosity of the filling means (known feature). During the process, the porosity of the sludge area becomes lower than the porosity of the filling means under the effect of the sludge growth.

While the quantity increases (by the increase in the biofilm thickness and in the dimensions of the sludge particles contained in the inner and interstitial pores of the filling means) the porosity of the supporting means is reduced with consequent increase in the effective rising speed in the sludge area. The increase in the effective rising speed due to the reduction of the filling means porosity (under the effect of the accumulation of the sludge) favors the flow conditions by plug which have a smoothing and rolling action of the sludge present in the interstitial pores, which takes the typical rounded and beveled shape of a river pebbles (from here the term granular sludge). Such sludge granules (pebbles) take then such dimensions that they cannot go out from the pores where they are developed/grown (i.e. they become granules trapped in the filling material).

It is to be specified that this compacting action is possible since the liquid crosses the sludge area by plug motion (plug-flow) and is free of gas bubble thus avoiding the above described scouring phenomena.

The features of the filling material (dimensions of inner and interstitial voids) have a decisive role in containing/holding granules. With inner void it is intended the voids inside the filling material while with interstitial voids it is intended the voids generated by packing various elements of the material in bulk (i.e. voids between element and element) whose volume will be determined both by the shape (included the provision of tongues) and the dimension and shape of the elements.

The reduced dimensions of the voids allow to trap low quantities of sludge (lead to low sludge ages and so lead to low reductions of the sludge growth yield and so of the production of sludge). Vice versa, great dimensions of voids allow to develop granules of great dimensions with consequent increase in sludge age and reduction of the growth yield. Anyway, if sludge granules of great dimensions are desired to be obtained it is needed to give them a certain compactness and stability.

It is to be considered that, generally, while increasing the diameter of the granule its compactness is reduced. For this reason, the plant according to the present invention is conveniently operated with particular operational conditions, in the following described, in order to obtain granules which have high dimensions and high compactness at the same time.

In particular, as it will be described, in the sludge area, in all the process steps, there are no air and/or oxygen bubbles which would cause the scouring phenomenon, with detachment and dragging of part of the biofilm and granules. In addition to the operational conditions, another aspect which allows to optimize the sludge features is the fact that the granules are bounded in a particular porous supporting means. Such aspect, in addition to allow to reach a higher sludge concentration in tank (up to 50 kg per m³ of sludge area) gives the process a higher strength since the granules are protected from possible destabilizing phenomena which usually torment the systems with suspended granular sludge (the long term stability of the granular sludge structure represents, in the known plants, one of the main problems which has actually limited the diffusion of the technology with granular sludge).

As yet said, in the process according to the present invention, the operational conditions have a decisive role both for the formation and the maintenance in time of such sludge (biofilm and granules).

In particular, the periodicity with which waste water is inlet in the tank represents a crucial operational parameter for obtaining and maintaining such sludge.

In fact, such parameter, if well managed, leads to the alternation of “feast” (abundance) and “famine” (famine) conditions of organic substrates (pollutants commonly present in municipal sewage) which support in time the structure of such sludge. The alternation of such conditions improves the level of sludge compactness.

In the treatment process with the plant according to the invention waste water is inlet inside the plant at substantially constant time intervals, preferably between 2 and 6 times a day and more preferably between 3 and 4 times a day.

The process discontinuity and the high sludge concentration determine in the sludge layers the periodical occurrence of aerobic/anaerobic reactions conditions, which lead to metabolic decoupling of the anabolic and catabolic phase, such that energy is dissipated without compromising the purification efficiency. Therefore, to the reduction of the sludge production due to the great sludge age it is added the one due to metabolic decoupling.

The management of the volumetric organic load introduced during the starting step, compared to the volume of the sludge area represents another important operational parameter for obtaining such particular sludge kind (biofilm and granules mix) and its bounding in the porous means. By analyzing the equation (1) it is noted in fact that a too high volumetric organic load during this period (i.e. when there is still a low quantity of sludge in the sludge compartment) would determine an increase in sludge growing speed, with the reduction of its compactness and consequent risk of detachment from the filling material. In other words, the anchorage of the sludge to the supporting means would become weaker with the risk that the same could be dragged from the liquid rising.

Therefore, during the first two months after starting a new plant the maximum organic load applied is lower then 0.15 kgCOD/m³-d. Only after the first two months of the starting step the organic load can be increased and anyway, preferably, it is managed so that it does not exceed the value of 05 kgCOD/m³-d in the third and fourth starting month.

The rising speed of the liquid phase through the porous means determines instead the shearing stresses acting on the sludge; if it is kept in the described values its compactness and density increase.

The process implemented in a plant according to the present invention is provided with the following steps: supplying (or loading), recirculation, discharge and pause. The loading and recirculation steps can be overlapped for even considerable time fractions. This alternation of steps is conveniently controlled by an automation system based on a microprocessor and a timer which manages the functioning of the various devices interlocked to the plant: feeding pumps, recirculation pumps, aeration/oxygenation system, extraction pumps of the effluent treated. In addition, such system is connected to a series of level sensors and for detecting the physical and chemical parameters (in particular ammonia, oxidized nitrogen and COD) whose values, measured on line, can vary the times of the various steps.

During the feeding step, the waste water to be purified (screened or sedimented) is sent, by means of a suitable pump, in the bottom of the sludge area from where it rises up to the upper portion of the sludge area, while is subjected to a filtration with removal of suspended material, and falls then in the liquid phase area.

When a predetermined level in the liquid phase area is reached (fixed by the operator), also the recirculation pump is activated which begins to recirculate the liquid from the liquid phase area to the sludge one, thus beginning the recirculation step, while the feeding pump continues to inlet new sewage on the bottom of the sludge area (loading and recirculation steps overlapping). The recirculated liquid rises along the height of the sludge area and then falls in the liquid phase area, where it is oxygenated by insufflating air by means of a blower or compressor and suitable diffusors (or by means of injection of pure gaseous oxygen in the recirculation current) (4) from which it is repeatedly sent again in the sludge area to fall again in the liquid phase area.

With regards to the advantages of the waste water inlet in the bottom of the sludge area, it is to be specified that, in plants known at the state of the art (as for example the one described in EP2307323) the waste water to be treated is inlet exclusively in the aerator. Considering that the waste water is added to a portion of yet treated sewage present in the aerator, the addition of the completely mixed waste water in the aerator can lead, especially in cases of not very concentrated urban waste water, to a rather strong dilution. In this cases the waste water which is effectively inlet in the sludge area is not the sewage to be treated but the one deriving from its dilution with purified effluent, and so the concentration of COD could not be enough for activating the alternation of the “feast” (abundance) and “famine” (famine) conditions and which form the basis of the formation of granular sludges, of the selection of the microbial species with low growth rate (and so with low production of sludge), and the compactness of the traditional biomasses. In the plant according to the present invention, the waste water to be treated is instead inlet directly on the bottom of the sludge area from where it rises “not diluted” and by plug flow thus avoiding the just described drawbacks and guaranteeing a higher penetration in the inner layers of the sludge, needed to select the bacterial species with low growth rate which usually occupy the most inner layers of the sludge.

When in the liquid phase area it is reached a second prefixed level, a level sensor sends a signal to the automation system which turns off the feeding pump. The liquid continues instead to be recirculated and possibly aerated between the two areas for the whole recirculation step. During the recirculation step, the aeration system can follow the same functioning cycle of the recirculation pump (i.e. it can always remain in function) or can follow a discontinuous functioning in order to enhance the denitrification process.

Anyway, such process is always present also when the aeration system is active: this is possible thanks to the high concentration of the sludge present in the sludge area and to the dynamic functioning conditions of the process, which, inside the sludge, generate adjacent aerobic (in which there is nitrification) and anoxic areas (where there is denitrification).

The activation and deactivation intervals of the aeration system can be managed by the automation system of the plant on the basis of the concentration values of ammonia and oxidized nitrogen, measured online by suitable sensors. However, the automation system can turn off the aeration system any time, in case the concentration of the dissolved oxygen, measured by a suitable probe, exceeds a determined set-point value set by the operator (for example 6 mg/1).

In order to enhance the treatment capacity, needed in cases of agglomerates with low water provision or raw waste water (i.e. not sedimented) pure gaseous oxygen can be insufflated at predetermined time intervals directly on the bottom of the sludge area (by means of a dedicated pipe) or in the delivery pipe of the recirculation pump. It is to be precised that the oxygen flow is controlled by mass flow controller so that it is guaranteed the absence of bubbles which would destabilize the sludge area. In particular, it is possible to operate with pure oxygen flow values up to 60 NmL per m³ of recirculated liquid phase. The high pressure present in the recirculation pipe, generated by the sludge high concentrations in the sludge area (values up to 2.5 bar) guarantees a high efficiency of solubilization of the inlet gaseous oxygen flow.

The recirculation step ends when a predetermined time interval elapsed or when the values of the chemical parameters (such for example COD, ammonia nitrogen and oxidized nitrogen), connected to the automation system are lower than the maximum limits allowed by the regulations for discharging the effluent treated in the receiving bodies of water. When such situation occurs, the automation system determines the stop of the recirculation pump and the aeration system (end of the reaction step), thus activating the extraction pump of the effluent (which, in a preferred embodiment can be the same as the recirculation one) which actually begins the discharge step. The extraction of the purified effluent from the compartment of the liquid phase occurs up to when the liquid level (detected by a sensor) in such compartment does not reach a prefixed value (by the operator). When such situation occurs, the automation system will determine the turning off of the pump thus ending the discharge step. In place of the signal of the level probe, the automation system can use also the one (if present) of the flowrate totalizator.

During the pause step of the process, the plant is prepared to begin a new sequence of steps as the just described one. Moreover, during such step the cleaning operation of the sludge area is carried out (if needed).

The cleaning operation is needed since while the system continues to function there is a continuous increase in sludge concentration with consequent reduction of the filling material porosity which can determine, with low values, a partial occlusion (clogging) of the sludge area. In order to avoid such phenomenon, a cleaning operation is carried out with the aim to bring the porosity value again in a suitable interval for the correct functioning of the system, by means of “forced” extraction of a portion of the sludge present. The cleaning operation has the same role of the purge current in the traditional systems with activated sludge; both determine the production of sludge in excess of the process. Unlike the purge current, the cleaning operation is carried out in a discontinuous way, i.e. only at reaching a determined value of the loading losses recorded on the bottom of the sludge area. Such set-point sludge is chosen on the basis of various factors, such as the height of the sludge area, the kind and composition of the waste water to be treated, injection and flow of pure oxygen, and the kind and level of treatment to be carried out (carbon removal with or without nitrogen removal).

The cleaning operation is carried out with compressed air at 3-5 bar which is inlet for about 1-2 minutes by means of a dedicated pipe provided on the bottom of the sludge area.

According to another embodiment, in addition to the pipe on the bottom of the sludge area also a pipe can be used which develops along the height of the sludge area so that it reaches more efficiently also the higher layers. The compressed air jet determines the detachment of a portion of sludge from the plastic supporting material (mainly the one arranged in the lower portion); the sludge detached settles on the bottom of the sludge area and can be extracted as “liquid sludge” by activating a suitable pump. The functioning time of the extraction pump of the cleaning sludge is preferably set by the value provided by a probe sensible to the suspended solids, positioned in the liquid interspace under the filling material: a value of suspended solids lower than a threshold will determine the pump to be turned off. Once the discharge step and the possible cleaning operation of the bed of the sludge compartment are ended, the process provides a new sequence of steps as the just described one.

After describing the process desired to be implemented, it is described in the following a preferred embodiment of the plant according to the invention.

The plant according to the invention comprises at least a tank (1) subdivided in at least two distinct portions (2, 3) by one or more vertical partitions (23). The tank is subdivided in at least an accumulation area of the sludge (2) and at least an accumulation area of the liquid phase (3). In case of subdivision in more than two areas, preferably but not limitingly, the number of the liquid phase areas and the number of the sludge areas will be equal. For simplicity of description, in the drawings it was referred to tanks with rectangular shape, on the understanding that by suitable configuration of the partitions the plant can be realized with tanks with different shape plan, for example circular.

The vertical partitions (23) separating the various areas, as shown in FIG. 1, are lower than the walls of the tank (1), so that the liquid can overflow from an area to the other one by gravity, and in particular can overflow from the sludge area (2) to the liquid phase area (3). Preferably, the vertical partitions are less than 20 cm, preferably between 5 and 10 cm, lower than the walls of the tanks, but clearly the height needed depends on the flowrate of the liquid to be overflown for partition section.

The containment tank of the liquid phase has also the function of the liquid phase oxygenation, therefore it is provided with a suitable aeration system. Preferably, the aeration system comprises pans configured to inject air micro-bubbles, positioned on the bottom of the tank and connected to a compressor/blower.

As it is shown in FIG. 2, on the bottom of the sludge area (2) a series of double pipe couples develop, parallel to each other, for feeding waste water (4) and liquid phase (5) respectively, air for cleaning operations (both on the bottom and at mid height) and pure oxygen. On each one of these pipes, at regular intervals, there are provided branches for introducing air, pure oxygen and waste water and liquid phase.

The sewage is inlet under the containment material. The cleaning air can be inlet both under the containment material and along the height of the same (at least up to mid height). This allows to carry out a more efficient cleaning.

Therefore, inside the sludge area, there is provided a regular arrangement of branches for feeding air, pure oxygen, waste water and liquid phase. Preferably the distance in both directions between two inlet branches is between 1 and 3 meters, and more preferably between 1.5 and 2 meters.

Still on the bottom of the sludge area, on one of the walls of the tank there are provided a series of holes for housing pressure probes for measuring the loading loss needed for the cleaning operations to be carried out.

Still in the same sludge area (2) there are provided higher (21) and lower (22) planes for the containment (packing) of the porous material (24).

Said planes are configured so that waste water, liquid phase and cleaning air flowrate pass, holding the porous material. The containment lower plane is horizontal and preferable positioned on the feeding pipes of air, pure oxygen, waste water and liquid phase. The higher containment plane is instead inclined (with a maximum inclination of 5° to the horizontal) so that the liquid is conveyed more rapidly towards the spillway partition thus avoiding that the same can stagnate in the area on the sludge area with possible proliferation of weeds above all in the periods of maximum incidence of the solar radiation.

Each one of the two containment planes will be provided with housings for mounting a suitable number of diffusors for the introduction of waste water and cleaning air and for recirculation of the liquid phase. Preferably there will be provided between 20 and 50 diffusors per m2, each one provided with between 4 and 12 openings between 3 and 5 mm for the introduction of waste water which, as known, contains also suspended particles.

As yet said, the volume of the sludge area (2), comprised between the two horizontal containment planes is filled with a porous means having a specific surface comprised between 500 and 800 m2/m3, a porosity higher than 80%, preferably between 82% and 90%, and dimensions of the single element between 5 and 20 mm and preferably between 7 and 18 mm. The single element is also of such geometry that it is subdivided in 3 or more areas. According to a preferred embodiment the single element is made up of a plastic cylinder, provided inside with partitions and on the outer surface with tongues. For a good functioning, elements of such geometry have such dimensions that they have inner and interstitial voids (generated by the packing of the various elements) between 90 and 500 mm³, and preferably between 120 and 350 mm³.

After describing the configuration of the tanks, it is now possible to describe the plant engineering provision of the same.

Each liquid phase areas (3) is connected with the bottom of a sludge area (2) by means of one or more dedicated pipes (preferably between 2 and 4) and suitable pumping means which allow to make the liquid flow from the liquid phase area (3) to the sludge area (2).

Preferably, the liquid, free of suspended material, suitably aerated, is sucked from the lower part of the liquid phase area (3) and inlet in the sludge area (2) by means of the previously described feeding pipes and branches.

It is suitable to underline that sucking liquid from the lower part of the liquid area (3) serves to avoid to drag towards the sludge area the air bubbles present in the liquid phase area since, obviously, the gas bubbles tend to go upwards. Moreover, the possible injection of pure oxygen in the recirculation pipe of the liquid phase or in the bottom of the sludge area is carried out in a controlled way, i.e. by metering oxygen so that the saturation concentration is not exceeded, so that the formation of bubbles in the sludge area is avoided, which would cause scouring phenomena.

Preferably, the liquid phase flowrate (and waste water flowrate during the feeding step) is such that in the sludge areas (2) there is a geometrical rising speed between 2 and 5 m/h, and more preferably between 2.5 and 3.5 m/h. The effective rising speed (effective rising speed) is clearly higher since a portion of the passage section is occupied by the porous material and the sludge developing during the process.

The liquid, once reached the upper portion of the partition of the sludge area (2), falls by gravity from the liquid phase area again in the higher portion of the liquid phase area (3) (it is to be remembered that the inner partitions are lower than the peripheral ones of the tank), and it is pumped again from the liquid phase areas to the sludge areas.

The plant is provided also with at least a feeding pipe of the waste water to be treated inside the sludge areas (3), with at least a recirculation pipe of the liquid from the liquid phase area to the sludge area and at least a discharge pipe of the effluent treated, withdrawn from the liquid phase area (3). Both these pipes are provided with suitable pumping means and controlled valves which allow their use at predetermined times.

Obviously all the valves of the plant and the movement pumps of the waste water and liquid phase can be interlocked to automation and control systems which allow their control both in manual way and by means of programmed logics, by means of a microprocessor.

1. A urban waste water treatment plant, comprising:
a tank (1) subdivided into at least two distinct portions (2, 3), said at least two distinct portions (2, 3) comprising at least an accumulation area of the sludge (2) and at least an accumulation area of the liquid phase (3),
at least a feeding pipe of the waste water to be treated;
at least a recirculation pipe of the liquid phase;
at least a discharge pipe of the effluent treated, withdrawn from said at least one accumulation area of the liquid phase (3),
wherein said feeding pipe of the waste water to be treated is configured so that the waste water is inlet on the bottom of said at least one sludge area;
wherein inside said at least one sludge area (2) it is provided porous material, contained between two containment planes, configured to allow the filtration of the waste water with removal of the suspended material;
wherein said tank (1) is subdivided into said at least two distinct portions by means of one or more vertical partitions (23) lower than the walls of the tank (1), so that the liquid from which the suspended material was removed in said at least one sludge area (2) can overflow from said at least one sludge area (2) to said at least one liquid phase area (3);
wherein the bottom of said at least one liquid phase area (3) is connected with the bottom of said at least one sludge area (2) by means of a pipe and pumping means which allow the liquid to recirculate from the bottom of the liquid phase area (3) to the bottom of the sludge area (2).

2. The urban waste water treatment plant according to claim 1, wherein said porous material is made up of elements with porosity higher than 0.8, dimensions between 5 and 20 mm and volume of interstitial voids between 90 and 500 mm³.

3. The urban waste water treatment plant according to claim 1, wherein said higher one of said containment planes is inclined of maximum 5° to the horizontal direction.

4. The urban waste water treatment plant according to claim 1, wherein said liquid phase area (3) comprises an aeration system configured to inject air on the bottom of said liquid phase area (3).

5. The urban waste water treatment plant according to claim 2, wherein said elements comprise plastic cylinders provided with inner partitions.

6. The urban waste water treatment plant according to claim 2, wherein said elements comprise also tongues on the outer surface.

7. A method for urban waste water treatment by means of the plant according to claim 1, comprising the steps of:
introducing the waste water to be purified, previously screened or sedimented, on the bottom of said at least one sludge area (2), so that the waste water crosses bottom-up said porous material by plug movement, thus separating from the suspended solids, and arrives up to the level of said partitions (23), from which the only liquid phase of the waste water falls in said at least one liquid phase area (3),
recirculating the liquid from the bottom of said liquid phase area (3) to the bottom of said sludge area (2), so that the liquid rises again, with a geometric rising speed between 1 and 5 m/h, along the height of said at least one sludge area (2),
crossing said porous material, and arrives up to the level of said partitions (23), to fall then again in said at least one liquid phase area (3), from the bottom of which it is again and repeatedly sent, by means of said pumping means, to the bottom of said sludge area (2);
oxygenating the liquid phase provided in said at least one liquid phase area (3) by insufflating air;
extracting the waste water treated from said at least one liquid phase area (3).

8. The method for urban waste water treatment according to claim 7, further comprising the formation of a particular kind of sludge (biofilm and granular sludge mix), bounded on the surface and voids of the porous means, which allows to reach in the sludge area sludge quantities up to 50 kg SS per m3 of filling material, which cause sludge age values greater than 100 days.

9. The method for urban waste water treatment according to claim 7, further comprising further, during the recirculation of liquid from said at least one liquid area (3) to said at least one sludge area (2) the following step of:
oxygenating the liquid phase by insufflating gaseous pure oxygen in the recirculation pipe, with oxygen flows between 10 and 60 NmL/h per m³ of recirculated liquid and preferably between 10 and 50 NmL/h per m³ of recirculated liquid.

10. The method for urban waste water treatment according to any one of claim 7 wherein said geometrical rising speed is between 2.5 and 3.5 m/h.

11. The method for urban waste water treatment according to claim 7, wherein for said introducing step of the waste water to be treated, the quantities a day of waste water introduced are such that the volumetric organic load introduced during the first 2 months of the starting step is lower than 0.15 of COD per m³ of filling material and a day (kgCOD/m³-d), and lower than 0.5 kg of COD per m³ of filling material and a day (kgCOD/m³-d) in the third and fourth month of the starting step.

12. The method for urban waste water treatment according to claim 7, wherein said stop of pumping means occurs when the values of the chemical parameters describing the pollutant load in said waste water, measured by means of suitable sensors, are lower than a predetermined threshold.

13. The method for urban waste water treatment according to claim 7, wherein after said extraction of said waste water from said tank, if the load loss measured between upstream and downstream of said porous means exceeds a value between 1 and 2.5 bar the cleaning step of said porous means is carried out by means of compressed air at 1-4 bar, and preferably between 2 and 3 bar, insufflated from the bottom of said sludge area (2).

14. The method for urban waste water treatment according to claim 13, wherein the cleaning step of said porous means is interrupted when the load loss measured between upstream and downstream of said porous means results to be lower than 70% of between 1 and 2.5 bar.

15. The method for urban waste water treatment according to claim 8, wherein the sludge extracted from the bottom of the sludge area has a ratio SV/SS equal or lower than 0.6.
